(19) United States
(12) Patent Application Publication
(10) Pub. No.: US 2022/0391851 A1
(43) Pub. Date: Dec. 8, 2022

(54) ONLINE CONFERENCING WITH FOOD SERVICE

(71) Applicant: Dell Products L.P., Round Rock, TX (US)

(72) Inventors: Shibi Panikkar, Bangalore (IN); Rohit Gosain, Bangalore (IN); Dhilip Kumar, Bangalore (IN)

(73) Assignee: Dell Products L.P., Round Rock, TX (US)

(21) Appl. No.: 17/380,364

(22) Filed: Jul. 20, 2021

(30) Foreign Application Priority Data
Jun. 4, 2021 (IN) 202141025022

(51) Int. Cl. G06Q 10/10; G06Q 50/12; G06Q 30/04; G06Q 20/14

(52) U.S. Cl. CPC G06Q 10/1095; G06Q 50/12; G06Q 30/04; G06Q 20/14

(57) ABSTRACT

In one aspect, an example methodology implementing the disclosed techniques includes, responsive to a determination, by a computing device, of a scheduling of an online conference between a plurality of conference participants, the online conference including food service, determining a food service application that is appropriate for at least one conference participant in the online conference. The method also includes sending to the at least one conference participant a notification regarding the scheduling of the online conference that includes food service, wherein the notification includes a link to the food service application. The method may also include, responsive to a receipt of a bill for a food order placed with the food service application by the at least one conference participant, collecting an amount from a conference organizer to pay for the food order and making an appropriate payment to the food service application to pay for the food order.

### CROSS REFERENCE TO RELATED APPLICATION

This application claims the benefit of India Patent Application No. 202141025022 filed on Jun. 4, 2021 in the English Language in the India Intellectual Property Office, the contents of which are hereby incorporated herein by reference in its entirety.

### BACKGROUND

The ubiquitous characteristic of the internet coupled with the proliferation and technological advances in electronic communication has led to a paradigm shift in the way people communicate and network with one another. For example, in lieu of the traditional in-person business meetings, companies are allowing employees to conduct online or virtual conferences and collaborations. Even outside of the business setting, people are now connecting with friends and others virtually online and foregoing the in-person gatherings.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, responsive to a determination, by a computing device, of a scheduling of an online conference between a plurality of conference participants, the online conference including food service, determining a food service application that is appropriate for at least one conference participant in the online conference. The method also includes sending to the at least one conference participant a notification regarding the scheduling of the online conference that includes food service, wherein the notification includes a link to the food service application.

In some embodiments, the food service application is determined based on a region in which the at least one conference participant is located.

In some embodiments, the notification includes an indication that the food service is to be paid by a conference organizer that scheduled the online conference. In one aspect, the notification includes an indication of a maximum amount that is to be paid for the food service by the conference organizer.

In some embodiments, the notification includes an indication that the food service is to be paid the at least one conference participant.

In some embodiments, the method also includes, responsive to a receipt of a bill for a food order placed with the food service application by the at least one conference participant, collecting an amount from a conference organizer to pay for the food order and making an appropriate payment to the food service application to pay for the food order.

In some embodiments, collecting the amount from the conference organizer includes debiting a payment account associated with the conference organizer.

In some embodiments, making the appropriate payment to the food service application includes a conversion from a first currency to a second currency.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to, responsive to a determination of a scheduling of an online conference between a plurality of conference participants, the online conference including food service, determine a food service application that is appropriate for at least one conference participant in the online conference. Execution of the instructions also causes the one or more processors to send to the at least one conference participant a notification regarding the scheduling of the online conference that includes food service, wherein the notification includes a link to the food service application.

In some embodiments, the food service application is determined based on a region in which the at least one conference participant is located.

In some embodiments, the notification includes an indication that the food service is to be paid by a conference organizer that scheduled the online conference. In one aspect, the notification includes an indication of a maximum amount that is to be paid for the food service by the conference organizer.

In some embodiments, the notification includes an indication that the food service is to be paid the at least one conference participant.

In some embodiments, execution of the instructions further causes the one or more processors to, responsive to a receipt of a bill for a food order placed with the food service application by the at least one conference participant, collect an amount from a conference organizer to pay for the food order and make an appropriate payment to the food service application to pay for the food order.

In some embodiments, to collect the amount from the conference organizer includes to debit a payment account associated with the conference organizer.

In some embodiments, to make the appropriate payment to the food service application includes a conversion from a first currency to a second currency.

According to another illustrative embodiment provided to illustrate the broader concepts described herein, a method includes, responsive to a determination, by a computing device, of a scheduling of an online conference between a conference organizer and at least one conference participant, the online conference including food service, determining a type of food that is appropriate for the at least one conference participant and determining a food service application for at least one conference participant based on a region in which the at least one conference participant is located. The method also includes sending to the at least one conference participant a notification regarding the scheduling of the online conference that includes food service, wherein the notification includes an indication of the type of food that is to be served during the online conference, and wherein the notification includes a link to the food service application.

In some embodiments, the notification includes an indication that the food service is to be paid by a conference organizer. In one aspect, the notification includes an indication of a maximum amount that is to be paid for the food service by the conference organizer.

In some embodiments, the notification includes an indication that the food service is to be paid the at least one conference participant.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to, responsive to a determination of a scheduling of an online conference between a conference organizer and at least one conference participant, the online conference including food service, determine a type of food that is appropriate for the at least one conference participant and determine a food service application for at least one conference participant based on a region in which the at least one conference participant is located. Execution of the instructions also causes the one or more processors to send to the at least one conference participant a notification regarding the scheduling of the online conference that includes food service, wherein the notification includes an indication of the type of food that is to be served during the online conference, and wherein the notification includes a link to the food service application.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 schematically shows a client-server system in which the disclosed concepts, structures, and techniques may be advantageously embodied, in accordance with an embodiment of the present disclosure.

FIG. 2 is a block diagram of an example online conference system that can be used to schedule an online conference that includes food service, in accordance with an embodiment of the present disclosure.

FIG. 3 is a diagram showing an example network topology that can be used to schedule an online conference that includes food service, in accordance with an embodiment of the present disclosure.

FIG. 4 is a diagram showing an example network topology that can be used to process payment for food service included in an online conference, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

While many efficiencies and benefits have been derived from the use of online conferences, online conferences suffer from certain shortcomings and disadvantages. For example, food served during a meeting can serve an icebreaker and a shared interest that all attendees of the meeting enjoy. In addition, serving food helps to strengthen the bond and relations among the meeting attendees, which can help stimulate creativity and fresh ideas to achieve the specific purpose or goal of the meeting. Unfortunately, unlike in-person meetings, existing online or virtual conferencing tools do not allow for similar team building opportunities and benefits.

Embodiments of the concepts, techniques, and structures disclosed herein are directed to integration of online conferences (also known as online meetings) and food service. Aspects of certain of the embodiments disclosed herein allow for specifying the inclusion of food service with a scheduled online conference. For example, and according to an embodiment, a conference organizer can use a conference client application to schedule an online conference (sometimes referred to herein more simply as a “conference”) with one or more conference participants. When scheduling the conference, along with providing the needed conference information (e.g., a scheduled date and time for the conference, a conference duration, conference participant information, etc.), the conference organizer may specify whether food service is to be a part of or otherwise included with the scheduled conference. If the conference organizer specifies that food service is included, the conference organizer may optionally specify the type of food (e.g., snacks, refreshments, breakfast, lunch, dinner, etc.) that is to be included with the scheduled conference. Having specified the inclusion of the food service with the scheduled conference, the conference organizer can also specify whether the food service is to be paid by the conference organizer or is to be paid individually by the conference participants. In cases where the conference organizer is paying for the food service, the conference organizer may specify a maximum amount that will be paid for each conference participant. The conference organizer can then complete or otherwise finish the scheduling of the conference, causing the conference client application the send or otherwise provide the scheduled conference details to a conference server application.

In response to receiving the scheduled conference details, the conference server application can send or otherwise provide a notification of the scheduled conference to each invited conference participant. For example, the conference server application can send an email to the individual invited conference participants. Additionally or alternatively, the conference server application can send a push notification (e.g., a text message) to the individual invited conference participants. In any case, the email and the notification to the conference participants may include controls to allow the conference participant to indicate whether they will accept or decline the invite. In cases where food service is included with the scheduled conference, the email and the notification may include information informing of the included food service along with details regarding the included food service. The email and the notification may also include a hyperlink (sometimes referred to more simply as a “link”) to a prepared food service application (sometimes referred to herein as a “food service application” or more simply as a “food application”) that is appropriate for the region in which the conference participant is located. For example, for a conference participant located in the United States, the food application may be UBER EATS® or SEAMLESS®. As another example, for a conference participant located in India, the food application may be Swiggy™. As another example, for a conference participant located in Bulgaria, the food application may be Foodpanda™. In any case, the provided link may reference or point to a food application that services the region in which the conference participant is located.

The conference participant can then click, tap, or otherwise activate the link to access the food application. For example, clicking on the provided link may open the food application on the conference participant's computing device. When opened, in some embodiments, the food application may provide information regarding the food service that is being provided with the scheduled conference. For example, if the food service is to be paid by the conference organizer, the food application can display a notification to this effect as well as the maximum amount that will be paid by the conference organizer for the food ordered by the conference participant. Alternatively, if the food service is to be paid by the conference participant, the food application can display a notification that the conference participant is responsible for paying for the food ordered by the conference participant. In either case, the conference participant may use a computing device to access the food application and place a food order to be delivered to the conference participant prior to the scheduled conference time. Note that the conference participant can click on the provided link and place a food order at any time prior to the scheduled conference time. Also note that the conference participant need not place a food order even if food service is included with the scheduled conference. The food application can process the food order in a manner as to cause the ordered food to be delivered to the conference participant prior to the scheduled conference time for consumption and enjoyment during the conference.

In some embodiments, the conference server application can convert the maximum amount specified by the conference organizer to a local currency of each conference participant. For example, suppose that the conference organizer is in the United States and that the specified maximum amount is $20.00 USD. Also suppose that a first conference participant is in South Korea and a second conference participant is in India. In this example case, the conference server application can covert the $20.00 USD to an equivalent amount in Korean won (KRW) for the first conference participant and an equivalent amount in Indian rupee (INR) for the second conference participant. In such embodiments, the food service application in South Korea (e.g., YOGIYO®) can display the maximum amount specified by the conference organizer in KRW and process a food order placed by the first conference participant in KRW. Likewise, the food service application in India (e.g., Swiggy™) can display the maximum amount specified by the conference organizer in INR and process a food order placed by the second conference participant in INR. The food service application in the United States (e.g., UBER EATS®) can display the maximum amount specified by the conference organizer in USD and process a food order placed by the conference organizer in USD.

In some embodiments, the conference server application includes a payment manager for processing payment for the food service included in a scheduled conference. In such embodiments, the payment manger may be configured to process payments (e.g., online payments) to the food service applications. For example, when a conference participant accesses a food application and places a food order that is to be paid by a conference organizer, the food application can notify the conference participant of a price of the food order (e.g., send a bill for the placed food order to the conference participant's computing device). Upon receiving the bill for the placed food order, the conference participant's computing device can forward or otherwise send the bill for the food order to the payment manager. The payment manager can then collect the amount requested in the bill (e.g., the price of the food order) from the conference organizer and make (e.g., remit) an appropriate payment to the food service application to pay for the food order that was placed by the conference participant. In one embodiment, the payment manager may make the payment after completion of the scheduled conference.

In some embodiments, the conference server application may allow users (e.g., conference organizer) to create payment accounts for making payments to food service applications. Then, if a payment account has been created for a conference organizer, the payment manager can send or otherwise provide an invoice for a food order(s) (e.g., food order(s) placed by conference participant(s)) to the conference organizer, and the conference organizer or another authorized user can authorize payment of the amount requested in the invoice from an appropriate payment account. Upon receiving the authorization for payment, the payment manager can withdraw (debit) the funds from the payment account and make an appropriate payment to the food service application(s).

In some embodiments, the payment manager may process payments in a local currency of the food service application. For example, suppose that the conference organizer is in the United States and that a conference participant in India places a food order with a food application in India (e.g., Swiggy™). In this case, since a bill for the food order may be for an amount in INR, the payment manager can convert the INR amount to an equivalent amount in USD, collect payment from the conference organizer in USD, and make an appropriate payment in INR to the food service application in India.

In some embodiments, the payment manager may consolidate the processing of the bills for food orders that are associated with a food service included in a scheduled conference. For example, suppose that three food orders placed with three different food service applications are associated with a food service included in a scheduled conference. In this example case, the payment manager can receive three separate bills informing of a price of a food order from the three different food service application. Upon receiving the three bills, the payment manager can collect the total amount (e.g., the total amount requested in the three bills) from the conference organizer. Upon receiving the total amount from the conference organizer, the payment manager can make (e.g., remit) an appropriate payment to each of the three food applications to pay for the food order that was placed with the food application.

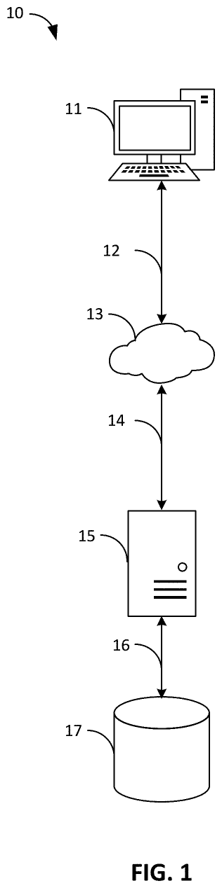

Turning now to the figures, FIG. 1 schematically shows a client-server system 10 in which the disclosed concepts, structures, and techniques may be advantageously embodied, in accordance with an embodiment of the present disclosure. In accordance with client-server principles, the system 10 includes at least one client device coupled for bidirectional data communication with at least one server device using a data network. Generally, the client requests, via the data network, that the server perform a computation or other function, and the server responsively fulfills the request, optionally returning a result or status indicator to the client via the data network.

Thus, system 10 includes a client device 11. Client device 11 is illustrated as a desktop computer, but may be any electronic device known in the art, including without limitation a laptop computer, tablet computer, smartphone, embedded system, or any other device capable of transmitting and receiving data, and requesting that another electronic device perform a computation.

As shown in FIG. 1, client device 11 is coupled, via a data link 12, to a data network 13. Data link 12 is any combination of hardware or software suited for communicating data between client device 11 and other electronic devices via data network 13. Data link 12 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

Data network 13 is any combination of hardware or software suited for communicating data between electronic devices via data links. Data network 13 may be, for example, a local area network (“LAN”), a wide area network (“WAN”), a metropolitan area network (“MAN”), a virtual private network (“VPN”), the Internet, or any other type of data network.

It is appreciated that data network 13 operates to mediate data communication between multiple electronic devices. Thus, the depiction of only a single client device 11 in FIG. 1 is merely illustrative, and system 10 may have any number of client devices coupled for data communication using corresponding data links to data network 13. It is also appreciated that data network 13 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

Data network 13 allows client device 11 to communicate with a server device 15, which is coupled to data network 13 using a data link 14. Data link 14 is any combination of hardware or software suited for communicating data between server device 15 and other electronic devices via data network 13. Server device 15 may be any electronic device known in the art that is capable of transmitting and receiving data, and performing a computation on behalf of another electronic device.

Again, data network 13 operates to mediate data communication between multiple electronic devices. Thus, the depiction of only a single server device 15 in FIG. 1 is merely illustrative, and system 10 may have any number of server devices coupled for data communication using corresponding data links to data network 13. In particular, to provide simultaneous service to large numbers of client devices, a particular computation (or type of computation, such as rendering a web page) may be allocated to one of multiple server devices using a load balancer or other device. It is further appreciated that server device 15, along with additional server devices if required, may provide well-defined operations known as “services” according to a service-oriented architecture (“SOA”), as those terms are known in the art.

It is appreciated in accordance with client-server principles that the designation of device 11 as the “client device” and device 15 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of system 10, namely that client device 11 is the device requesting that a particular computation be performed on behalf of a user thereof, and that server device 15 operates a “service” to perform the computation and communicate the results to client device 11. A typical protocol for such interaction is the Hypertext Transfer Protocol (“HTTP” or “HTTP/1.1”) specified as a proposed Internet Standard by Requests for Comment (“RFC”) 7230 through 7235, which is used to implement the World Wide Web.

FIG. 1 shows server device 15 coupled, via a storage link 16, to a data storage device 17. Data storage device 17 may be a database, file system, volatile or non-volatile memory, network attached storage (“NAS”), storage area network (“SAN”), or any other hardware or software that is capable of storing data used by server device 15 or a service executing thereon. Storage link 16 may be any hardware or software capable of communicating data between server device 15 and data storage device 17. It is appreciated that, where more than one server device 15 is present, multiple server devices may communicate with the same data storage device 17 to provide data sharing between the server devices.

It is appreciated that a requested computation may be done in several parts, thereby requiring system 10 to retain an intermediate computational state between requests. If the services provided by server device 15 do not store any such state (for example, to simplify their design), then client device 11 may supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

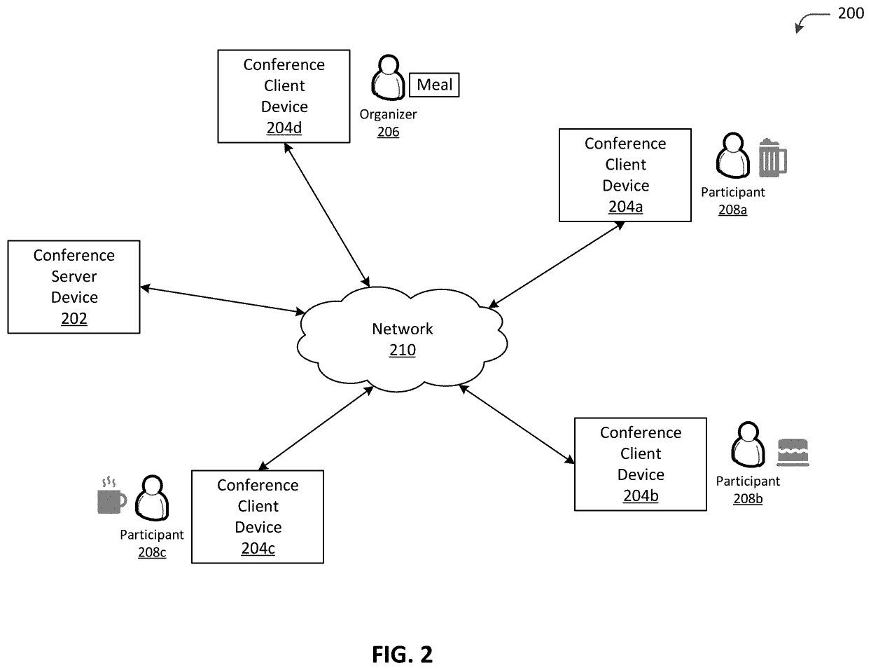

FIG. 2 is a block diagram of an example online conference system 200 that can be used to schedule an online conference that includes food service, in accordance with an embodiment of the present disclosure. As shown, in some implementations, online conference system 200 includes a conference server device 202 communicatively coupled to conference client devices 204a-204d (individually referred to herein as conference client device 204 or collectively referred to herein as conference client devices 204) via a network 210.

Network 210 may correspond one or more to wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, and Near Field Communication (NFC) networks. In some embodiments, network 210 may include another network or a portion or portions of other networks. For example, in some implementations, network 210 may correspond to data network 13 of FIG. 1, described previously.

Conference server device 202 can include any computing device configured to accept and respond to requests made over a network. In some embodiments, conference server device 202 may be substantially similar to server device 15 described above in the context of FIG. 1.

Conference client device 204 can include smartphones, tablet computers, laptop computers, desktop computers, or other computing devices configured to run user applications. In some embodiments, conference client device 204 may be substantially similar to client device 11 described above in the context of FIG. 1.

The number of conference client devices 204 depicted in online conference system 200 is for illustration, and those skilled in the art will appreciate that there may be a different number of conference client devices 204, including very large numbers of conference client devices 204. Also, in other implementations, online conference system 200 may not have all of the elements shown in FIG. 2 and/or may have other elements including other types of elements instead of, or in addition to, some or all of the elements shown in FIG. 2. For example, online conference system 200 may include more than one conference server device 202.

Still referring to online conference system 200 of FIG. 2, a conference organizer 206 and conference participants 208a-208c (individually referred to herein as conference participant 208 or collectively referred to herein as conference participants 208) may communicate with each other using respective conference client devices 204a-204d. For example, conference organizer 206 can use conference client device 204d to schedule an online conference that includes food service with one or more conference participants (e.g., conference participants 208). Conference organizer 206 and conference participants 208 can user their respective conference client devices 204 to join and participate in (e.g., attend) the scheduled online conference. Once joined, conference participants 208, including conference organizer 206, may use their respective conference client devices 204 to interact with each other during the online conference, where respective conference client devices 204, operating or otherwise functioning as conference client devices, transmit or otherwise provide media streams to each other. Note that, in cases where conference organizer 206 joins an online conference (e.g., an online conference session), conference organizer 206 becomes, in effect, one of the conference participants.

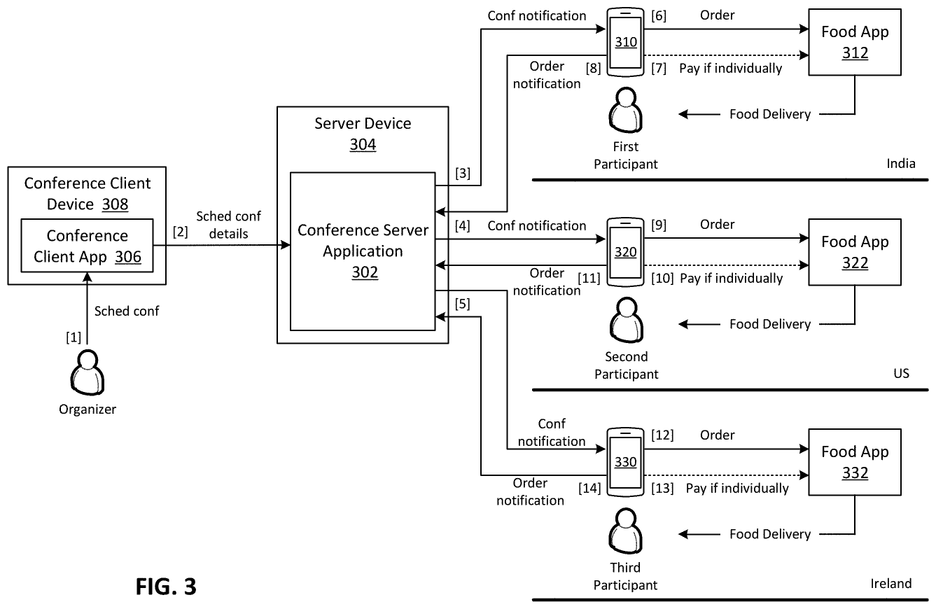

FIG. 3 is a diagram showing an example network topology that can be used to schedule an online conference that includes food service, in accordance with an embodiment of the present disclosure. Such a topology can be understood as a process in which a user (e.g., a conference organizer) can leverage the services provided by a conference server application 302 to schedule an online conference that includes food service. Conference server application 302 may provide collaboration and communication functionality to allow users to host and/or participate in an interactive, online conferences (online meetings) from various locations. For example, as depicted in FIG. 3, conference server application 302 may be provided as a service (e.g., a Software as a Service (SaaS) application) provided on a server device 304. Server device 304 can include any computing device configured to accept and respond to requests made over a network. In some embodiments, server device 304 may be substantially similar to server device 15 described above in the context of FIG. 1 and/or conference server device 202 described above in the context of FIG. 2.

In an illustrative use case, a conference organizer can use a conference client application 306 executing on a client device 308 to access the services provided by conference server application 302. Conference client application 306 may provide an entry point for users, such as the conference organizer, to access conference server application 302. Client device 308 can include any computing device such as smartphones, tablet computers, laptop computers, or desktop computers, configured to run conference client application 306. In some embodiments, client device 308 may be substantially similar to client device 11 described above in the context of FIG. 1 and/or conference client device 204 described above in the context of FIG. 2.

As shown in FIG. 3, the conference organizer can use conference client application 306 to schedule [1] an online conference that includes food service. To schedule the online conference, the conference organizer may provide details regards the scheduled online conference such as the organizer's name, a title (or subject) of the online conference, online conference date and time, online conference duration, indication that food service is included in the online conference, whether the food service is to be paid individually or by the conference organizer, a maximum amount that will be paid for the food service for each conference participant, and a list of conference participants. For each conference participant, the conference organizer may provide conference participant information such as conference participant name, contact information (e.g., email address, phone number, etc.), and the conference participant's location or region. In one embodiment, the conference organizer may optionally specify the type of food (e.g., snacks, refreshments, breakfast, lunch, dinner, etc.) that is included with the scheduled online conference. Indicating the type of food may serve as a suggestion to the conference participants as to what type of food may be appropriate to order. Upon entering the conference details, the conference organizer can complete or otherwise commit to the scheduling of the online conference, for example, by selecting a “Save” or “Send” or other appropriate user interface control provided by conference client application 306. In response, conference client application 306 can send or otherwise provide [2] the online conference details to conference server application 302 for processing.

In response to receiving the online conference details, conference server application 302 can determine from the provided information that food service is included in the scheduled online conference and the details regarding the included food service such as whether the food service is to be paid individually or by the conference organizer and any indicated maximum amount that will be paid for the food service for each conference participant. Conference server application 302 can also determine from the provided information the conference participants that are to be invited as well as other information regarding the conference participants such as their contact information and location/region information. Conference server application 302 can then determine a food service application that is appropriate for each conference participant based on the indicated location/region for the conference participant. For example, suppose that the provided online conference details indicate that three conference participants, a first participant, a second participant, and a third participant, are to be invited to the scheduled online conference. Also suppose that the provided online conference details indicate that the first participant is in India, the second participant is in the United States, and the third participant is in Ireland. In this example case, based on the indicated location information, conference server application 302 can determine that a food application 312 (e.g., Swiggy™) services India and is appropriate for the first participant, a food application 322 (e.g., SEAMLESS®) services the United States and is appropriate for the second participant, and a food application 332 (e.g., UBER EATS®) services Ireland and is appropriate for the third participant.

Conference server application 302 can then send a notification of the scheduled online conference to each invited conference participant (e.g., the first participant, the second participant, and the third participant). For example, in one implementation, conference server application 302 can send a push notification (e.g., an text message) to a mobile phone or other device capable of receiving the push notification using the phone number specified for the conference participant. Conference server application 302 can also send an email notification using the email address specified for the conference participant. In any case, the notification can include information regarding the scheduled online conference and controls to allow a user to accept or decline the invite to the scheduled online conference. Since food service is included, the notification can include information regarding the included food service (e.g., type of food, organizer paid or individually paid, maximum amount that will be paid for the conference participant, etc.) along with a link to a food service application that services the region in which the conference participant is located.

The conference participant can then click, tap, or otherwise activate the link that is provided in the notification to open the food service application. In some embodiments, when opened, the food service application may provide (e.g., display) information regarding the food service that is included in the scheduled online conference. For example, in an implementation, the information regarding the scheduled online conference and the included food service can be passed or otherwise sent to the food service application as parameters in a uniform resource locator (URL). Passing such information in this manner allows the food service application to be informed of the details of the scheduled online conference including whether a food order that is placed via the link is to be paid by a conference participant, for example, at the time the food order is placed, or whether the food order is to be paid by the conference organizer, for example, at a later time (e.g., subsequent to the time the food order is placed by the conference participant).

For example, as shown FIG. 3, conference server application 302 can send [3] a notification of the scheduled online conference to a mobile device 310 of the first participant. The notification sent to the first participant can include information regarding the scheduled online conference and controls for accepting or declining the invite to the scheduled online conference, information informing of the included food service, and a link to food application 312. Conference server application 302 can also send [4] a notification of the scheduled online conference to mobile device 320 of the second participant. The notification sent to the second participant can similarly include information regarding the scheduled online conference and controls for accepting or declining the invite to the scheduled online conference, information informing of the included food service, and a link to food application 322. Conference server application 302 can also send [5] a notification of the scheduled online conference to a mobile device 330 of the third participant. The notification sent to the third participant can similarly include information regarding the scheduled online conference and controls for accepting or declining the invite to the scheduled online conference, information informing of the included food service, and a link to food application 332. As described above, in some implementations, conference server application 302 can additionally or alternatively send an email notification to the first, second, and/or third participants.

Note that, while three conference participants are illustrated in FIG. 3 for purposes of clarity, it will be appreciated that the scheduled online conference can be between any number of conference participants, including a very large number of conference participants. Also note that, while three different regions are illustrated in FIG. 3 for purposes of clarity, it will be appreciated that the conference attendees may be located one, tow, or a larger number of different regions. Further, a region can include multiple conference participants.

Still referring to FIG. 3, the first participant may receive the notification on mobile device 310, and use the link provided in the notification to access food application 312 and place [6] a food order for the scheduled online conference. If the food service is to be paid individually (i.e., paid by the first participant) and not by the conference organizer, the first participant can pay [7] for the food order that is placed with food application 312. If the food service is to be paid by the conference organizer, food application 312 does not collect payment from the first participant for the placed food order. Food application 312 can then process the food order placed by the first participant in a manner as to cause the ordered food to be delivered to the first participant prior to the scheduled conference time for consumption and enjoyment during the online conference. In some embodiments, upon the first participant placing the food order, mobile device 310 can send [8] a notification informing of the placing of the food order by the first participant to conference server application 302. The notification may include information such as an identifier that uniquely identifies the food order, the price of the food order, whether the food order was paid by the conference participant, the amount paid by the conference participant, and the food items that were ordered, among others. The notification enables conference server application 302 to monitor or otherwise keep track of the status of the food service that is included in the scheduled online conference. For example, in cases where the food service is to be paid by the conference organizer, conference server application can inform the conference organizer of the details regarding the food order that was placed, including the price of the food order.

In a manner similar to that of the first participant described above, the second participant may receive the notification on mobile device 320, and use the link provided in the notification to access food application 322 and place [9] a food order for the scheduled online conference. If the food service is to be paid individually, the second participant can pay [10] for the food order that is placed with food application 322. If the food service is to be paid by the conference organizer, food application 322 does not collect payment from the second participant for the placed food order. Food application 322 can then process the food order placed by the second participant in a manner as to cause the ordered food to be delivered to the second participant prior to the scheduled conference time for consumption and enjoyment during the online conference. In some embodiments, upon the second participant placing the food order, mobile device 320 can send [11] a notification informing of the placing of the food order by the second participant to conference server application 302.

Similarly, the third participant may receive the notification on mobile device 330, and use the link provided in the notification to access food application 332 and place [12] a food order for the scheduled online conference. If the food service is to be paid individually, the third participant can pay [13] for the food order that is placed with food application 332. If the food service is to be paid by the conference organizer, food application 332 does not collect payment from the third participant for the placed food order. Food application 332 can then process the food order placed by the third participant in a manner as to cause the ordered food to be delivered to the third participant prior to the scheduled conference time for consumption and enjoyment during the online conference. In some embodiments, upon the third participant placing the food order, mobile device 330 can send [14] a notification informing of the placing of the food order by the third participant to conference server application 302.

Note that, in cases where the conference organizer is also a conference participant, conference server application 302 can determine a food service application that is appropriate for the conference organizer and provide the conference organizer a notification that includes a link to the food service application. For example, conference server application 302 can include the link to the food service application in a notification reminding the conference organizer of the scheduled online conference. The conference organizer can then use the link provided in the reminder notification to access the food service application and place a food order for the scheduled online conference.

Note that a conference participant can click on the link provided in the notification and place a food order at any time subsequent to receiving the notification. In some embodiments, the link provided in the notification may become dead or deactivated (i.e., become an inactive link) once the scheduled online conference is started.

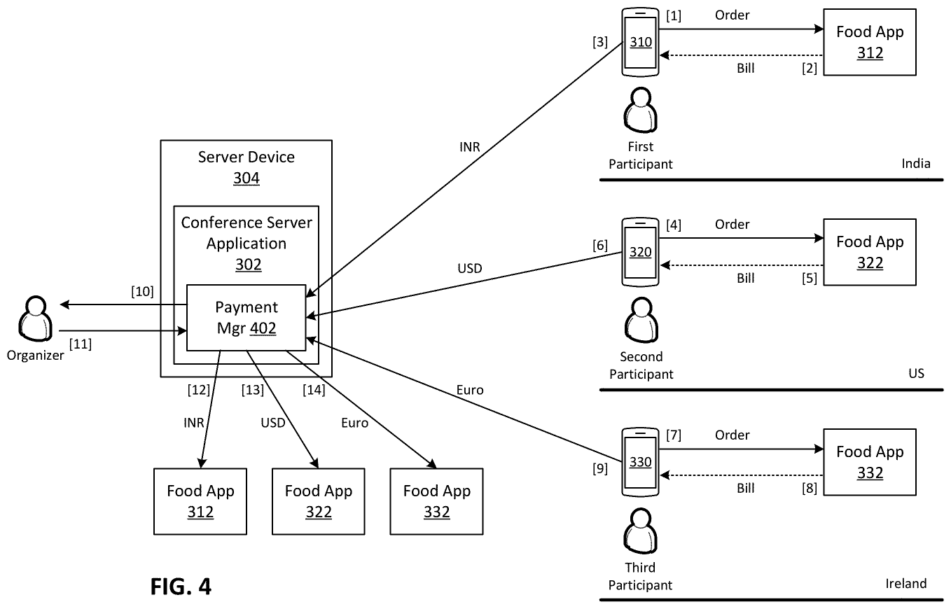

Turning to FIG. 4, in which like elements of FIG. 3 are shown using like reference designators, shown is an example network topology that can be used to process payment for food service included in an online conference, in accordance with an embodiment of the present disclosure. Unless context dictates otherwise, those elements in FIG. 4 that are labelled identically to elements of FIG. 3 will not be described again for the purposes of clarity. In particular, FIG. 4 shows a topology in which the payment for the food service is made by an organizer of the online conference.

As shown, conference server application 302 includes a payment manager 402. In some embodiments, payment manager 402 is configured to process payments for food service included in scheduled online conferences. To this end, as will be further described below, payment manager 402 can receive bills for food orders associated with food service included in a scheduled online conference, collect payment to pay the received bills, and pay the received bills. In some such embodiments, payment manager 402 may make the necessary currency conversions to account for different currencies.

With continued reference to the illustrative use case of FIG. 3 above, as shown in FIG. 4, the first participant can use the link provided in the notification to access food application 312 and place [1] a food order for the scheduled online conference. For example, the first participant can use mobile device 310 to activate the link provided in the notification. In processing the food order, food application 312 can determine that the food order placed by the first participant is to be paid by the conference organizer. For example, as described previously, information indicating that the food service included in the scheduled online conference may be passed as a parameter in the URL associated with the link. Thus, when food application 312 is accessed via the link, food application 312 can determine from the URL parameter that the food order placed via use of the link (i.e., the food order placed for the scheduled online conference) is to be paid by the organizer of the scheduled online conference. Based on this determination, food application 312 can send [2] a bill for the placed food order to the first participant. For example, in an implementation, food application 312 can send the bill for the placed food order to the computing device (e.g., mobile device 310) that is used to activate the link to access food application 312 and place the food order. Upon receiving the bill, mobile device 310 can forward or otherwise send [3] the bill for the food order placed by the first participant to payment manager 402 for payment processing, for example. Note that the bill from food application 312 is likely to be for an amount in INR since the first participant is in India.

Similar to the first participant, the second participant can use the link provided in the notification to access food application 322 and place [4] a food order for the scheduled online conference. For example, the second participant can use mobile device 320 to activate the link provided in the notification. In processing the food order, food application 322 can determine that the food order placed by the second participant is to be paid by the conference organizer. As described previously, information indicating that the food service included in the scheduled online conference may be passed as a parameter in the URL associated with the link. Thus, when food application 322 is accessed via the link, food application 322 can determine from the URL parameter that the food order placed via use of the link (i.e., the food order placed for the scheduled online conference) is to be paid by the organizer of the scheduled online conference. Based on this determination, food application 322 can send [5] a bill for the placed food order to the second participant. For example, in an implementation, food application 322 can send the bill for the placed food order to the computing device (e.g., mobile device 320) that is used to activate the link to access food application 322 and place the food order. Upon receiving the bill, mobile device 320 can forward or otherwise send [6] the bill for the food order placed by the second participant to payment manager 402 for payment processing, for example. Note that the bill from food application 322 is likely to be for an amount in USD since the second participant is in the United States.

Similarly, the third participant can use the link provided in the notification to access food application 332 and place [7] a food order for the scheduled online conference. For example, the third participant can use mobile device 330 to activate the link provided in the notification. In processing the food order, food application 332 can determine that the food order placed by the third participant is to be paid by the conference organizer. As described previously, information indicating that the food service included in the scheduled online conference may be passed as a parameter in the URL associated with the link. Thus, when food application 332 is accessed via the link, food application 332 can determine from the URL parameter that the food order placed via use of the link (i.e., the food order placed for the scheduled online conference) is to be paid by the organizer of the scheduled online conference. Based on this determination, food application 332 can send [8] a bill for the placed food order to the third participant. For example, in an implementation, food application 332 can send the bill for the placed food order to the computing device (e.g., mobile device 330) that is used to activate the link to access food application 332 and place the food order. Upon receiving the bill, mobile device 330 can forward or otherwise send [9] the bill for the food order placed by the third participant to payment manager 402 for payment processing, for example. Note that the bill from food application 332 is likely to be for an amount in Euro since the third participant is in Ireland.

Upon receiving the bills for the food orders associated with the food service included in the scheduled online conference, payment manager 402 can pay the received bills. To do so, as shown in FIG. 4, payment manager 402 can send [10] an invoice for the food orders to the conference organizer. The invoice can be for a total amount due for the food orders. For instance, in the illustrative use case above, the invoice can for an amount that is the sum of the amounts specified in the three bills from food applications 312, 322, 332 for the food orders placed by the first participant, the second participant, and the third participant.

In some embodiments, payment manager 402 can process payments in a local currency of the food service application. Continuing the illustrative use case above, suppose that the conference organizer is in the United States. In this case, payment manager 402 can convert the amounts specified in each of the three bills to an equivalent amount in USD. For example, payment manager 402 can convert the amount specified in INR in the bill from food application 312 to an equivalent amount in USD, and convert the amount specified in Euro in the bill from food application 332 to an equivalent amount in USD. Note that no currency conversion of the amount specified in the bill from food application 322 is necessary since the amount is in USD (i.e., the amount indicated in the bill is in the same currency as the local currency of the conference organizer). Upon converting the amounts, payment manager 402 can send the invoice for the food orders for an amount in USD to the conference organizer.

Upon receiving the invoice, the conference organizer can make [11] an appropriate payment of the amount indicated in the invoice to payment manager 402. In some embodiments, the conference organizer, or another authorized user, can authorize a payment of the amount indicated in the invoice from a payment account created or otherwise established with payment manager 402. In this case, payment manager 402 can withdraw (debit) the amount needed to pay the invoice from the payment account. In any case, upon receiving payment from the conference organizer, payment manager 402 can make appropriate payments to the food service applications for the food orders associated with the food service included in the scheduled online conference.

To process payments in a local currency of the food service application, payment manager 402 can convert the amount collected from the conference organizer to the currency that is appropriate for the food service application. Continuing the illustrative use case above, payment manager 402 can convert an appropriate portion of the amount collected from the conference organizer in USD to INR to pay the bill for the food order placed by the first participant, and convert an appropriate portion of the amount collected from the conference organizer in USD to Euro to pay the bill for the food order placed by the third participant. Again, note that no currency conversion is necessary to pay the bill for the food order placed by the second participant. As shown in FIG. 4, payment manager 402 can then make [12] an appropriate payment in INR to food application 312 to pay for the food order placed by the first participant, make [13] an appropriate payment in USD to food application 322 to pay for the food order placed by the second participant, and make [14] an appropriate payment in Euro to food application 332 to pay for the food order placed by the third participant.

In some embodiments, payment manager 402 may additionally or alternatively receive a bill for a food order directly from a food service application. For example, in the illustrative use case above, food application 312 can also send the bill for the food order placed by the first participant directly to payment manager 402 for payment processing. In some such embodiments, payment manager 402 can process payment of a received bill by reconciling the bill with a notification from a conference participant indicating that the conference participant did in fact place the food order with the food service application.

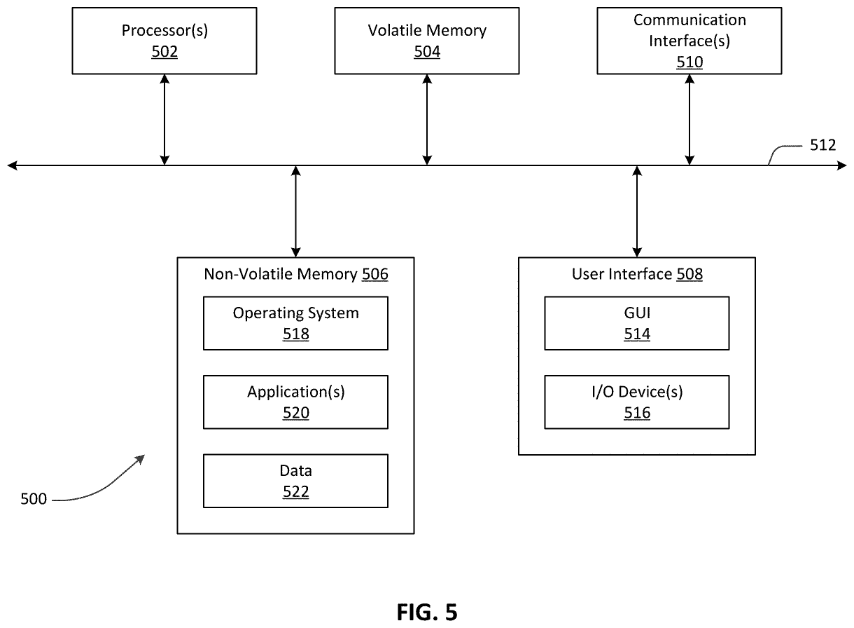

FIG. 5 is a block diagram illustrating selective components of an example computing device 500 in which various aspects of the disclosure may be implemented, in accordance with an embodiment of the present disclosure. For instance, client devices 11, server devices 15 and/or other electronic devices of FIG. 1 can be substantially similar to computing device 500. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described in reference to FIGS. 2 through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

1. A method comprising:
displaying, by a computing device, a notification of a scheduled online conference within a user interface (UI) on the computing device, the notification being sent by a conference server application, the notification including a link to a food service application;
responsive to activation of the link to access the food service application, sending, by the computing device, information about the scheduled online conference to the food service application, wherein the information about the scheduled online conference includes information regarding whether a food order placed via the link is to be paid at the time the food order is placed or by a conference organizer;
responsive to the food order being placed with the food service application, sending, by the computing device, a notification informing of the placing of the food order to the conference server application; and
responsive to receiving a bill for the food order from the food service application, forwarding, by the computing device, the bill for the food order to the conference server application for processing of payment of the bill.

2. (canceled)

3. The method of claim 1, wherein the notification includes an indication that the food service is to be paid by the conference organizer.

4. The method of claim 3, wherein the notification includes an indication of a maximum amount that is to be paid for the food order by the conference organizer.

5. The method of claim 1, wherein the notification includes an indication that the food service is to be paid by a conference participant.

6. The method of claim 1, further comprising:
responsive to a receipt of the bill for the food order:
collecting, by the conference server application, an amount from a conference organizer to pay the bill for the food order; and
making an appropriate payment to the food service application to pay the bill for the food order.

7. The method of claim 6, wherein collecting the amount from the conference organizer includes debiting a payment account associated with the conference organizer.

8. The method of claim 6, wherein making the appropriate payment to the food service application includes a conversion from a first currency to a second currency.

9. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to:
display a notification of a scheduled online conference within a user interface (UI) on the computing device, the notification being sent by a conference server application, the notification including a link to a food service application;
responsive to activation of the link to access the food service application, send information about the scheduled online conference to the food service application, wherein the information about the scheduled online conference includes information regarding whether a food order placed via the link is to be paid at the time the food order is placed or by a conference organizer;
responsive to the food order being placed with the food service application, send a notification informing of the placing of the food order to the conference server application; and
responsive to receiving a bill for the food order from the food service application, forward the bill for the food order to the conference server application for processing of payment of the bill.

10. (canceled)

11. The system of claim 9, wherein the notification includes an indication that the food order is to be paid by the conference organizer.

12. The system of claim 11, wherein the notification includes an indication of a maximum amount that is to be paid for the food order by the conference organizer.

13. The system of claim 9, wherein the notification includes an indication that the food order is to be paid by a conference participant.

14. (canceled)

15. (canceled)

16. (canceled)

17. A non-transitory machine-readable medium encoding instructions that when executed by one or more processors cause a process to be carried out, the process including:
displaying, by a computing device, a notification of a scheduled online conference within a user interface (UI) on the computing device, the notification being sent by a conference server application, the notification including a link to a food service application;
responsive to activation of the link to access the food service application, sending, by the computing device, information about the scheduled online conference to the food service application, wherein the information about the scheduled online conference includes information regarding whether a food order placed via the link is to be paid at the time the food order is placed or by a conference organizer;
responsive to the food order being placed with the food service application, sending, by the computing device, a notification informing of the placing of the food order to the conference server application; and
responsive to receiving a bill for the food order from the food service application, forwarding, by the computing device, the bill for the food order to the conference server application for processing of payment of the bill.

18. The machine-readable medium of claim 17, wherein the notification includes an indication that the food order is to be paid by the conference organizer.

19. The machine-readable medium of claim 18, wherein the notification includes an indication of a maximum amount that is to be paid for the food order by the conference organizer.

20. The machine-readable medium of claim 18, wherein the notification includes an indication that the food order is to be paid by a conference participant.
